(19) United States
(12) Patent Application Publication
(10) Pub. No.: US 2019/0124950 A1
(43) Pub. Date: May 2, 2019

(54) CANINE ELECTROLYTE RESTORATION AND BALANCING COMPOSITION AND METHOD OF FORMATION

(71) Applicant: Emiliano Gabriel Flores, Phoenix, AZ (US)

(72) Inventor: Emiliano Gabriel Flores, Phoenix, AZ (US)

(21) Appl. No.: 16/172,512

(22) Filed: Oct. 26, 2018

Related U.S. Application Data
(60) Provisional application No. 62/577,336, filed on Oct. 26, 2017.

(51) Int. Cl. A23K 20/174; A23K 20/24; A23K 20/163; A23K 50/42; A23K 50/48

(52) U.S. Cl. CPC A23K 20/174; A23V 2250/712; A23K 20/163; A23K 50/42; A23K 50/48; A23V 2002/00; A23V 2200/02; A23V 2200/15; A23V 2200/30; A23V 2250/16; A23V 2250/161; A23V 2250/1614; A23V 2250/702; A23V 2250/7052; A23V 2250/706; A23K 20/24

(57) ABSTRACT

Disclosed is a pet electrolyte restoration and balancing composition and method of formation. A mixture, some variations of which include one or more electrolytes such as potassium, calcium, and magnesium and one or more vitamins, such as vitamin C and multiple B-vitamins, increases pet health and physical performance while decreasing susceptibility to environmental or metabolic stress and disease. An excipient aqueous-based delivery system to provide bioavailability of a palatable, convenient, orally-ingested composition is included. Methods of formation are also described.

### CROSS REFERENCE TO RELATED APPLICATION

This application claims priority from U.S. Provisional Patent Application No. 62/577,336, filed Oct. 26, 2017 and entitled “Canine Electrolyte Restoration and Balancing Composition and Method of Formation,” which is incorporated entirely herein by reference.

### BACKGROUND OF THE INVENTION

### Technical Field

This invention relates to electrolyte restoration and balancing compositions for dogs and other house pets. In particular, the invention relates to compositions incorporating potassium, magnesium, calcium, vitamins, and flavor enhancements in various combinations, methods of formation, and methods of formation.

### State of the Art

Dehydration and electrolyte imbalances occur in dogs and other house pets. Significant dehydration can follow vigorous or prolonged outdoor exercise in a hot climate through panting. Profound losses of electrolytes, particularly potassium and magnesium, may follow period of chronic diarrhea, vomiting, or certain other pet illnesses and endocrine conditions.

Currently available options for treating pets suffering from dehydration or electrolyte deficiencies are lacking, with virtually no commercially available products available for direct sale to consumers. Pet owners are limited, therefore, to consulting a veterinarian for information regarding which electrolytes or vitamins are needed, in what quantities and concentrations, and then creating a restoring mixture which is likely completely unpalatable to the dog or other pet.

Accordingly, what is needed is a pet-compatible rehydration and electrolyte restoration and balancing composition formulated to replenish electrolytes and provide essential vitamins, having a desirable taste, which, unlike water alone, restores electrolytes and vitamins for the pet.

### DISCLOSURE OF EMBODIMENTS OF THE INVENTION

Embodiments of the present invention include a pet electrolyte restoration and balancing composition, methods of formation, and methods of hydrating a domestic animal by using a pet electrolyte restoration and balancing composition. The foregoing and other features and advantages of the invention will be apparent to those of ordinary skill in the art from the following more particular description of the invention and the accompanying drawings.

Disclosed is a water-based composition comprising an electrolyte, a vitamin, and a flavor enhancement.

In some embodiments, the composition additionally comprises calcium. In some embodiments, the composition additionally comprises magnesium.

In some embodiments, the composition additionally comprises an antioxidant. In some embodiments, the composition additionally comprises a vitamin.

In some embodiments, the vitamin is vitamin A, as retinol. In some embodiments, the vitamin is vitamin B3 as niacinamide. In some embodiments, the vitamin is vitamin B6 as pyridoxine hydrochloride. In some embodiments, the vitamin is vitamin B12 as cyanocobalamin. In some embodiments, the vitamin is vitamin C as ascorbic acid. In some embodiments, the vitamin is vitamin E as alpha tocopherol acetate.

In some embodiments, the flavor enhancement is a natural savory enhancement. In some embodiments, the flavor enhancement is a fruit flavor enhancement. In some embodiments, the flavor enhancement is peanut butter. In some embodiments, the flavor enhancement is pumpkin. In some embodiments, the flavor enhancement is a natural flavor enhancement.

In some embodiments, the composition is packaged as a dry mixture for reconstitution in water. In some embodiments, the composition is packages as a water-based liquid.

Disclosed is a serving of a composition for veterinary use effective to restore normal plasma electrolyte levels comprising sodium chloride, potassium chloride, and magnesium chloride in an aqueous solution. In some embodiments, the total volume of the serving is about two-hundred fifty (250) milliliters.

In some embodiments, the amount sodium chloride is between about 50 milligrams (“mg”) and about 500 mg. In some embodiments, the amount of potassium chloride is between about 225 mg and about 1,250 mg. In some embodiments, the amount of magnesium chloride is between about 0.01 mg and about 0.05 mg.

In some embodiments, the composition additionally comprises calcium chloride. In some embodiments, the amount of calcium chloride is between about 250 mg and about 1,500 mg.

Disclosed is a method of forming a pet electrolyte restoring and balancing composition comprising a providing a solid mixture having sodium chloride, potassium chloride and magnesium chloride; batching the mixture with an additional ingredient; and adding water for form an aqueous pet electrolyte restoring and balancing composition.

In some embodiments, the mixture additionally comprises calcium chloride.

In some embodiments, the method further comprises a step packaging the pet electrolyte restoring and balancing composition into a consumer unit.

### BRIEF DESCRIPTION OF THE DRAWINGS

FIG. 1 is a schematic representation of a pet electrolyte restoring and balancing composition;

FIG. 2 is a flowchart showing steps of a method 200 for forming a pet electrolyte restoring and balancing composition; and

FIG. 3 is a flowchart showing steps of a method 300 for forming a pet electrolyte restoring and balancing composition.

### DETAILED DESCRIPTION OF EMBODIMENTS OF THE INVENTION

As mentioned herein above, the disclosed invention relates to rehydration compositions for pets. In particular, the invention relates to pet electrolyte restoring and balancing composition incorporating sodium chloride, potassium chloride, calcium chloride, and magnesium chloride in various combinations, methods of formation, and methods of formation.

Pets, including dogs, are prone to dehydration and development of electrolyte imbalances in multiple situations, including prolonged outdoor exercise, chronic diarrhea, chronic vomiting, and other illnesses. Dogs can suffer similar ill-effects associated with dehydration and electrolyte imbalances as humans, namely, hyper or hyponatremia, hypophosphatemia, hypocalcemia, and hypomagnesemia.

For example, rapid breathing and panting associated with prolonged exercise creates loss of water and, to a much lesser extent, associated losses of sodium, potassium, calcium, and magnesium in urine, feces. Initially, water loss creates a condition of hypernatremia, however, replacement of water in the absence of sodium and other electrolytes by drinking plain water will eventually dilute serum electrolytes, creating a condition of hyponatremia, hypokalemia, and hypomagnesemia. These and other electrolytes may also be lost in disease states associated with abnormal kidney function, prolonged vomiting, or prolonged diarrhea.

Sodium is an electrolyte essential to maintain proper osmolar gradients throughout the interstitial space; consequently, high sodium concentrations following loss of water by illness or exercise may lead to neurologic dysfunction, including confusion and seizures; weakness, nausea, and intracerebral hemorrhage. Maintenance of proper serum sodium concentrations through proper hydration is, therefore, essential.

Potassium, another electrolyte, is concentrated intracellularly and is necessary for a myriad of cellular metabolic and homeostatic processes. Loss of potassium can create low energy and muscle weakness, loss of appetite, muscle pain, paralysis, increases urination, and increased thirst. Unless the pet is suffering from vomiting or diarrhea, potassium is readily absorbed following oral administration in an aqueous solution.

Calcium is not an electrolyte, per se, but a mineral. For the purposes of this disclosure, however, calcium is described as an electrolyte. Calcium is necessary for proper bone formation and health, blood clotting, muscle contraction and relaxation, and nerve impulse conduction. Low calcium (hypocalcemia) in pets may arise from kidney disease, malnutrition or other conditions causing low protein states, and certain endocrine disorders.

Magnesium is an electrolyte which, in conjunction with sodium, is essential for proper electrochemical processes in the body. Magnesium is also a cofactor necessary for proper functioning of many enzymes. Consequently, proper magnesium levels are necessary for nerve conduction, cardiac muscle function, and intracellular energy production. Magnesium deficiency in dogs may be caused by kidney disease, malnutrition, or metabolic diseases—including diabetes. Metabolic stress resulting from extreme, prolonged exercise can also precipitate hypomagnesemia.

Some embodiments of the disclosed invention incorporate combinations of potassium, calcium, and magnesium as potassium chloride, calcium chloride, and magnesium chloride. Ingestion of a composition comprising safe, non-toxic amounts of these compounds, in different combinations, with or without the addition of other compounds, contributes to the health and well-being of a dog or other pet.

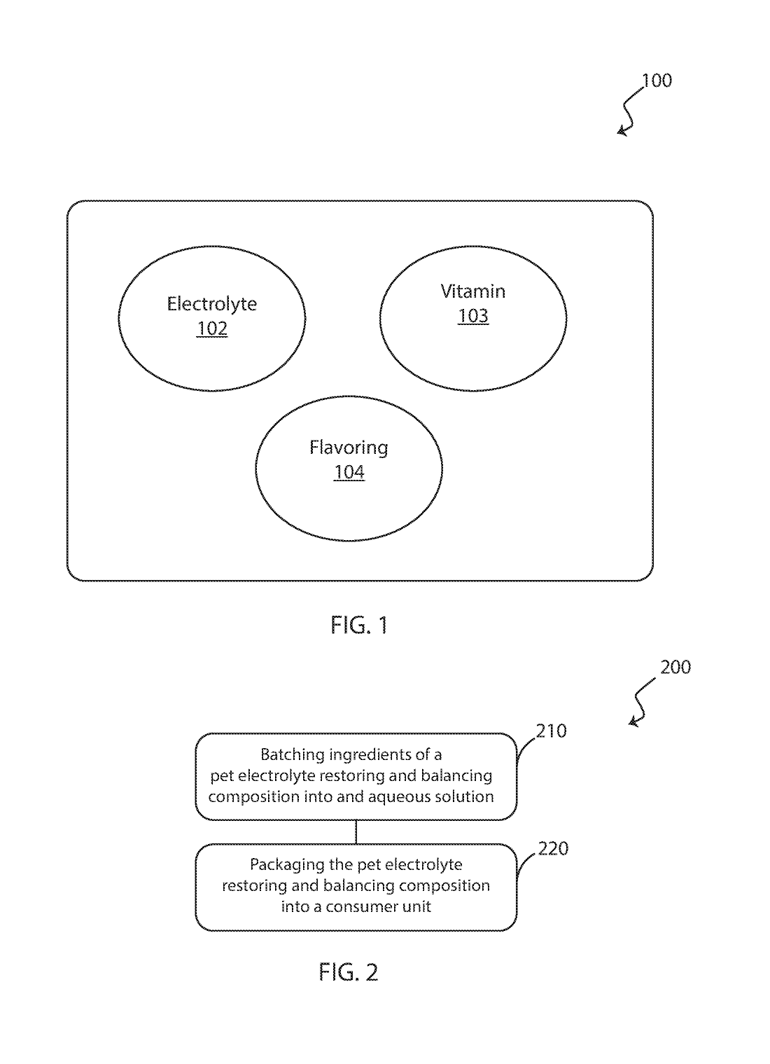

FIG. 1 is a schematic representation of a pet electrolyte restoring and balancing composition 100. Composition 100, as shown by FIG. 1, comprises an electrolyte 102, a vitamin 103, and a flavor enhancement 104.

As used herein, “flavor enhancement” means a flavor-additive selected to increase the palatability of a composition, in which the flavor enhancement is used, to a dog, a cat, other pet-animal, or other animal. A flavor enhancement me be a naturally occurring substance or compound, or a synthetic compound, without limitation.

As used herein, “electrolyte” means a substance that exists as an ion in the body and functions to buffer pH, regulate the flow of nutrients into a cell and waste products out of a cell, and to regulate cellular and other metabolic processes necessary for life in a pet or other animal. In some embodiments, electrolytes 102 comprise potassium, and magnesium, wherein, in some other embodiments, electrolytes 102 additionally comprise calcium. Where provided, calcium may be present in composition 100 as calcium chloride.

As used herein, “vitamin” means any one of a number of organic substances that cannot be synthesized by an animal but are necessary in small or minute quantities for normal growth and metabolism of an animal. Vitamin 103 includes a combination of one or more than one B-vitamins, in some embodiments. For example, in some embodiments, composition 100 comprises vitamin B3, as niacinamide. Vitamin B3 has a wide range of effects in a pet's body, promoting digestive, integumentary, and nervous system health. Vitamin 103 comprises a vitamin B12, as cyanocobalamin, in some embodiments. Vitamin B12 is necessary for red blood cell production and normal nerve cell function. Vitamin B6, as pyridoxine, is present in some embodiments of composition 100. Vitamin B6 promotes healthy central and peripheral nervous system function and also promotes immune system function and antibody production. In some embodiments of composition 100, vitamin 103 additionally comprises vitamin E, such as the acetate salt of d-alpha-tocopherol, for example. In these and some other embodiments, Vitamin E provides the pet consuming composition 100 with antioxidant properties to increase overall cellular health. As used herein, “antioxidant” means a substance that removes or neutralizes potentially damaging oxidizing agents or compounds in a living animal. Vitamin E additionally contributes to the pet's immune function. In some embodiments, composition 100 contains one or more other antioxidants.

Electrolyte restoration and balancing composition 100, in some embodiments, comprises flavor enhancement 104 in water to make composition 100 palatable and more suitable for ingestion by the pet. In some embodiments, flavor enhancement 104 comprises a fruit juice or extract. In some embodiments, flavor enhancement 104 comprises a beef extract. In some embodiments, flavor enhancement 104 comprises a chicken extract. In some embodiments, flavor enhancement 104 comprises a seed or nut butter, such as peanut butter. In some embodiments, flavor enhancement 104 comprises a vegetable or vegetable extract, such as pumpkin, for example. Flavor enhancement 104 may include flavor enhancements and additional natural, non-artificial compounds used in the pet food arts to make aqueous compounds more palatable and easy for a pet to ingest. Consequently, many choices and combinations of flavor enhancements and additional natural, non-artificial compounds are possible.

In some embodiments, composition 100 comprises a probiotic (not shown.)

FIG. 2 is a flowchart showing steps of a method 200 for forming a pet electrolyte restoring and balancing composition. As shown in FIG. 2, method 200 comprises a batching step 210; and a packaging step 220.

Batching step 210, in some embodiments, comprises batching ingredients of a pet electrolyte restoring and balancing composition into an aqueous solution.

Batching step 210, in some embodiments, comprises batching the various components listed herein together into an aqueous solution. Electrolytes 102 are typically stored as a dry crystalline powder, either as individual compounds of a mixture of compounds, prior to dissolution in water. In some embodiments, batching step 220 comprises mixing a concentrated solution of electrolytes 102 into a more dilute composition 100 to form the final desired concentration(s) of electrolytes comprised by electrolytes 102. In some embodiments, batching step 210 comprises a single step combining all ingredients together and mixing until the solid ingredients are completely dissolved into solution with the liquid ingredients. Vitamins 103 and flavor enhancements 104 may also be provided as a dry powder, either as single compounds or a dry mixture of compounds. Alternatively, vitamins 103 and flavor enhancements 104 may be provided as a concentrated liquid for combination with additional water or aqueous-based composition in amounts needed to obtain the desired final concentrations of composition 100.

In some embodiments, batching step 210 comprises multiple sub-steps (not shown in the FIG. 2) wherein the various ingredients of the pet electrolyte restoration and balancing composition are combined to form an aqueous solution. Following addition of all ingredients to the solution and complete dissolution of all solid ingredients into the solution, additional water is added, in some embodiments, to adjust the concentration of one or more than one of the ingredients in the solution. In some embodiments, the resulting solution is then mixed for about an additional amount of time, after which a final concentration of one or more than one of the ingredients is measured. In some embodiments, the solution is checked for taste.

Packaging step 220 comprises packaging the pet electrolyte restoring and balancing composition into a consumer unit. In some embodiments, packaging step 230 further comprises filling a screw-top plastic bottle with a quantity, such as about thirty-two (32) ounces, of the composition and screwing the screw top onto the bottle, sealing the consumer unit. In some embodiments, packaging step 230 comprises use of an alternative packaging container, such as a peel-top container, a can, a soft-foil package which the end user punctures to consume the electrolyte restoring and balancing composition within, or the like. In some embodiments, packaging step 220 further comprises affixing a label to the consumer unit. In some embodiments, packaging step 230 further comprises combining a plurality of consumer units into a group package for distribution to a retail outlet or a distributor for online sales to an individual consumer purchaser.

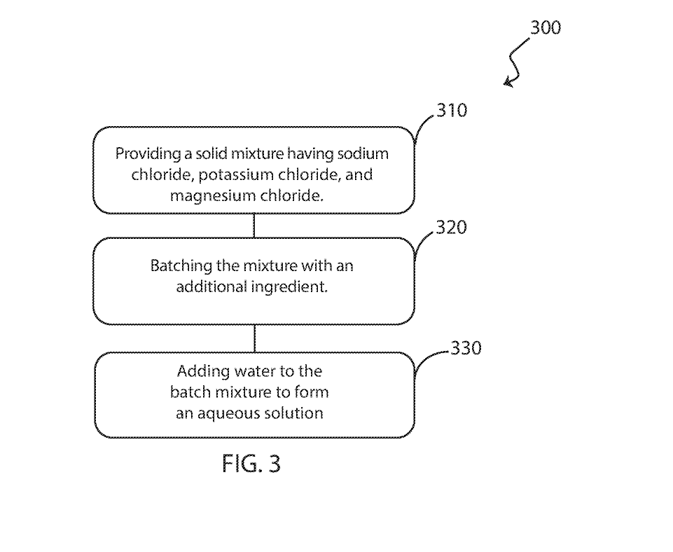

FIG. 3 is a flowchart showing steps of a method 300 for forming a pet electrolyte restoring and balancing composition.

As shown in FIG. 3, method 300 comprises a providing step 310 and a batching step 320. In some embodiments, method 300 additionally comprises a packaging step 330.

Providing step 310, in some embodiments, comprises providing a mixture comprising an electrolyte and a vitamin. In some embodiments, the mixture additionally comprises a flavor enhancement.

Batching step 320 is similar to batching step 210 described in detail herein above. Packaging step 330 is similar to packaging step 220 described in detail herein above.

Adding step 32Bat0 comprises adding water to the batch mixture to form an aqueous solution. In some embodiments, tap water is used. In some embodiments, purified water, such as water purified by distillation or reverse osmosis, for example, is used.

A pet electrolyte restoration and balancing composition, including methods of formation, is described. The pet electrolyte restoration and balancing composition is particularly suited for larger house pets, such as dogs, and provides a means for safe hydration and restoration of proper electrolyte and vitamin levels for a pet suffering from a deficiency of one or more electrolytes and vitamins caused by chronic diarrhea, vomiting, starvation/malnutrition, or prolonged outdoor exercise.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

What is claimed is:

1. A water-based composition for veterinary use comprising:
an electrolyte;
a vitamin; and
a flavor enhancement.

2. The composition of claim 1, further comprising calcium.

3. The composition of claim 1, further comprising magnesium.

4. The composition of claim 1, further comprising an antioxidant.

5. The composition of claim 1, wherein the vitamin is vitamin A.

6. The composition of claim 1, wherein the vitamin is vitamin B6.

7. The composition of claim 1, wherein the vitamin is vitamin B12

8. The composition of claim 1, wherein the vitamin is vitamin C.

9. The composition of claim 1, wherein the vitamin is vitamin E.

10. The composition of claim 1, wherein the flavor enhancement is a natural flavor enhancement.

11. The composition of claim 10, wherein the flavor enhancement is a natural savory enhancement.

12. The composition of claim 10, wherein the flavor enhancement is a fruit flavor enhancement.

13. The composition of claim 10, wherein the flavor enhancement is peanut butter.

14. The composition of claim 10, wherein the flavor enhancement is pumpkin.

15. The composition of claim 1, wherein the composition is packaged as a dry mixture for reconstitution in water.

16. The composition of claim 1, wherein the composition is packaged as a water-based liquid.

17. A serving of a composition for veterinary use effective to restore normal plasma electrolyte levels comprising:
sodium chloride;
potassium chloride; and
magnesium chloride.

18. The serving of claim 17, further comprising a vitamin.

19. The serving of claim 17, further comprising an antioxidant.

20. A method of forming a composition for veterinary use effective to restore normal plasma electrolyte levels comprising steps:
providing a solid mixture having sodium chloride, potassium chloride, and magnesium chloride;
batching the mixture with an additional ingredient; and
adding water to form an aqueous solution.
